(19) United States
(12) Patent Application Publication
(10) Pub. No.: US 2021/0058353 A1
(43) Pub. Date: Feb. 25, 2021

(54) System for Distributed Messages Via Smart Contracts

(71) Applicant: Capital One Services, LLC, McLean, VA (US)

(72) Inventors: Jacob Creech, Mckinney, TX (US); Jayaraman Ganeshmani, Plano, TX (US)

(21) Appl. No.: 16/549,327

(22) Filed: Aug. 23, 2019

(51) Int. Cl. H04L 12/58; H04L 9/06

(52) U.S. Cl. CPC H04L 51/12; H04L 9/0637; H04L 51/18; H04L 51/28; H04L 51/22

(57) ABSTRACT

Systems, as described herein, may include authorizing message transmission from message producers to message consumers in a variety of systems. Smart contracts in blockchain networks may be used to authorize messages from message producers to be sent to the consumers. Distributed ledgers in the blockchain network may be used to store messages authorized by the smart contracts and records of events related to the messages.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF USE

Aspects of the disclosure relate generally to distributed messaging systems and more specifically to distributed messaging systems implemented in a blockchain network.

### BACKGROUND

Distributed messaging is based on the concept of reliable message queuing. A stream of messages of a particular type may be defined as a topic. A topic is a category to which messages are published. A message producer may publish messages to a topic. The published messages may be stored at a set of servers called brokers. A message consumer may subscribe to one or more topics and consume the published messages from the brokers.

A distributed messaging system may comprise one or more nodes acting as message producers by producing messages, one or more nodes acting as brokers by queueing messages, and one or more nodes acting as message consumers by consuming messages. Example of distributed messing systems may include Apache Kafka, RabbitMQ, JMS (Java Message Service), ActiveMQ, ZeroMQ, and Kestrel.

Messages in a distributed messaging system may be prone to tampering. A malicious party may masquerade as a message producer to a topic and send messages unrelated to the topic to message consumers of that topic. A malicious party may also tamper with messages queued in the brokers. Thus, it is desirable to provide a distributed messaging system that is not vulnerable to tampering by malicious parties.

Aspects described herein may address these and other problems, and generally improve the quality, efficiency, and security of distributed messaging systems by using distributed ledgers and smart contracts on distributed networks for storing messages, and validating message producer, message consumers and messages from message producers.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems, as described herein, may use smart contracts and distributed ledgers in distributed networks as message brokering systems to process messages from message producers. Smart contracts in the distributed networks may maintain a registry of validated message producers and a registry of validated message consumers. Members of the registry of validated message producers may be approved by the smart contracts to send messages to one or more members of the registry of validated message consumers.

A smart contract may receive a first transaction executed by a message producer to join the registry of validated message producers of the smart contract. The smart contract may verify the first transaction by determining whether the first transaction comprises an indication to join the registry of validated message producers, and whether the first blockchain transaction is associated with encryption keys of the message producer. The smart contract may add the message producer to the registry of validated message producers based on the verification of the first transaction.

The smart contract may receive a second transaction executed by a message consumer to join the registry of validated message consumers in the smart contract. The smart contract may verify the second transaction by determining whether the second transaction comprises an indication to join the registry of validated message consumers, and whether the second transaction is associated with encryption keys of the message consumer. The smart contract may add the message consumer to the registry of validated message consumers based on the verification of the second transaction.

The smart contract may receive a third transaction executed by a validated message producer from the registry of validated message producers in the smart contract. The third transaction may comprise a message. The smart contract may verify the third transaction by determining whether the validated message producer is a member of the registry of validated message producers and whether the third transaction is associated with encryption keys of the validated message producer. The smart contract may send the message to one or more members of the registry of validated message consumers based on the verification of the third blockchain transaction.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an architectural level schematic of a distributed messaging system in which one or more aspects described herein may be implemented.

FIG. 2 shows an example computing device in accordance with one or more aspects described herein.

FIG. 3 shows an example of a smart contract in accordance with one or more aspects described herein.

FIG. 4 shows an example process for creating a smart contract in accordance with one or more aspects described herein.

FIG. 5 shows a timing diagram of a process for registering a new validated message producer in accordance with one or more aspects described herein.

FIG. 6 shows a timing diagram of a process for registering a new validated message producer in accordance with one or more aspects described herein.

FIG. 7 shows a timing diagram of a process for sending a message in accordance with one or more aspects described herein.

FIG. 8 shows a timing diagram of a process of receiving a message in accordance with one or more aspects described herein.

### DETAILED DESCRIPTION

In the following description of the various embodiments, reference is made to the accompanying drawings, which form a part hereof, and in which is shown by way of illustration, various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for directing messages from message producers to message consumers in a distributed messaging system. The distributed messaging system may provide an infrastructure for the set-up of message topics and processing of the messages related to the message topics. A message may include any kind of information or content. A message may store the information or content in various forms of objects and templates. A message, for example, may have information about an event that has happened, or it could just be a text message that triggers an event, an email regarding upcoming promotions of a merchant, and so on. The distributed messaging system may receive messages from a message producer regarding one or more topics, and send the messages to one or more message consumers. The distributed messaging system may interact with multiple message producers and consumers who are located outside the distributed messaging system.

Existing distributed messaging systems may have a number of drawbacks and limitations. Messages in existing distributed messaging systems may be prone to tampering as the existing distributing messaging system may interact with external computing devices and individuals. A malicious party may masquerade as a message producer to a topic and send messages unrelated to the topic to message consumers of that topic, such as spam emails, or spread threats, including malicious software (e.g., internet worms, Trojan horses, computer viruses and spyware). A malicious party may also tamper with messages queued in the distributed messaging system.

Distributed messaging systems, as described herein, allow for message processing between message producers and consumers without the drawbacks of existing distributed messaging systems. Distributed messaging systems may be implemented in a distributed network. A distributed network may be a blockchain network including a decentralized and distributed system that hosts distributed ledgers or blockchains among a set of computer nodes that may record transactions efficiently and in a verifiable and permanent way. The distributed ledgers may comprise blocks of blockchain transactions or records and other information pertinent to the blocks. Each block may contain a cryptographic hash and/or a pointer comprising an indication of the previous block, thereby creating a chain of blocks. The pointer may be an address of the previous block and/or a hash pointer comprising a hash of the data inside the previous block. The distributed ledger may create a permanent and unalterable electronic ledger of all transactions which have been written to the ledger since its inception. Examples of popular blockchain networks include Ethereum, Eris, Multichain, Bitcoin, Litecoin, Hyperledger Fabric, Credo Blockchain, and Hyperledger Corda. Distributed messaging systems, as described herein, may store messages in a distributed ledger in a blockchain network, thereby reducing the possibility of threats posed by malicious parties.

The distributed messaging system may use encryption keys of the message producer and the message consumers to validate them as credible message producers and consumers of a certain message topic. The distributed messaging system may also use encryption keys of the message producer to validate messages sent by the message producers. Messages validated by the distributed messaging system may be forwarded to message consumers. Encryption keys may be uniquely identified and linked to the owner of the encryption keys. Encryption keys may use pairs of keys: (i) public keys which may be disseminated widely, and (ii) private keys which are known only to the owner of the key. Encryption keys also may be electronic or digital signatures comprising a cryptographic mechanism to identify the owners of the signatures.

Distributed messaging systems may use smart contracts or digital contracts stored in a distributed network to manage messages of one or more topics. A smart contract may be computer code run by a computer node in the distributed network. The computer code for the smart contract may contain a set of rules under which the parties to that smart contract agree to interact with each other. If and when the pre-defined rules are met, the agreement is automatically enforced. A smart contract may also provide a storage mechanism for storing data related to the smart contract, such as the registries described herein. A smart contract may be associated with a smart contract address. The smart contract address may be a unique identifier for a smart contract stored using a blockchain network. In many embodiments, a smart contract address includes an alphanumeric string beginning with the characters “0x”.

The smart contract may comprise a registry of validated message producers and a registry of validated message consumers. The smart contract may comprise rules to validate a message producer or a consumer for a certain message topic. The smart contract may include the validated message producer as a member of the registry of validated message producers or the validated message consumer as a member of the registry of message consumers.

A message producer may request to be validated by a smart contract of a certain topic by executing a blockchain transaction addressed to the smart contract address of the smart contract. The blockchain transaction may indicate a request to join the registry of validated message producer and comprise a cryptographic signature unique to the message producer. The smart contract may determine whether the message producer is eligible to be a member of the registry of validated message producer based on a set of rules, such as the blockchain transaction executed by the message producer indicates a request to join the registry and the blockchain transaction comprises a cryptographic signature associated with the encryption keys of the message producer. The set of rules may further include rules that the blockchain transaction indicates a topic category of the messages they message producer will send later on, and so on.

A message consumer may request to be validated by a smart contract of a certain topic by executing a blockchain transaction addressed to the smart contract address of the smart contract. The blockchain transaction may indicate a request to join the registry of validated message consumers and comprise a cryptographic signature unique to the message consumer. The smart contract may determine whether the message consumer is eligible to be a member of the registry of validated message consumers based on a set of rules, such as the blockchain transaction executed by the message consumer indicates a request to join the registry and the blockchain transaction comprises a cryptographic signature associated with the encryption keys of the message consumers, and so on.

The smart contract may comprise rules to validate messages from message producers before forwarding them to the message consumers. A message producer may send a message by executing a blockchain transaction addressed to the smart contract address of the smart contract and comprising the message. The blockchain transaction may comprise a cryptographic signature unique to the message producer. The smart contract may validate the message based on a set of rules, such as the message producer being a member of the registry of validated message producers, the blockchain transaction comprises a cryptographic signature associated with the encryption keys of the message producer, the objects in the messages meeting certain requirements, and so on. The smart contract may use the public key of the message producers to verify the cryptographic signature of the blockchain transaction. In some embodiments, the smart contract may send a block number for the block storing the blockchain transaction executed by the message producer and comprising the message to the validated message consumers.

Verifications of the message consumers, message producers, and/or message using encryption keys may prevent malicious parties manipulating messages and sending messages unrelated to the topic to message consumers of that topic, such as spam emails, threats, and malicious software.

The distributed messaging system described herein may improve the functioning of computer systems by securely managing message flow from validated message producers to the validated message consumers. The distributed messaging system may securely manage the message flow by validating message producers who are able to send messages and validating message consumers who are able to receive messages, thereby reducing the risk of an unverified third party to sending or receiving messages. A message producer or consumer may request to be validated by the distributed messaging system by executing a blockchain transaction associated with their encryption key. The distributed messaging system may also securely manage the message flow by validating messages from validated message producers before sending the messages to the validated message consumers, thereby reducing the risk of sending malicious software or spam emails or messages to the validated message consumers. The distributed messaging system may also securely store the messages in the distributed ledger. Additionally, security may be further improved by only allowing access to a distributed ledger and/or blockchain network maintained by the distributed messaging system.

### Distributed Messing System Implemented on a Blockchain Network

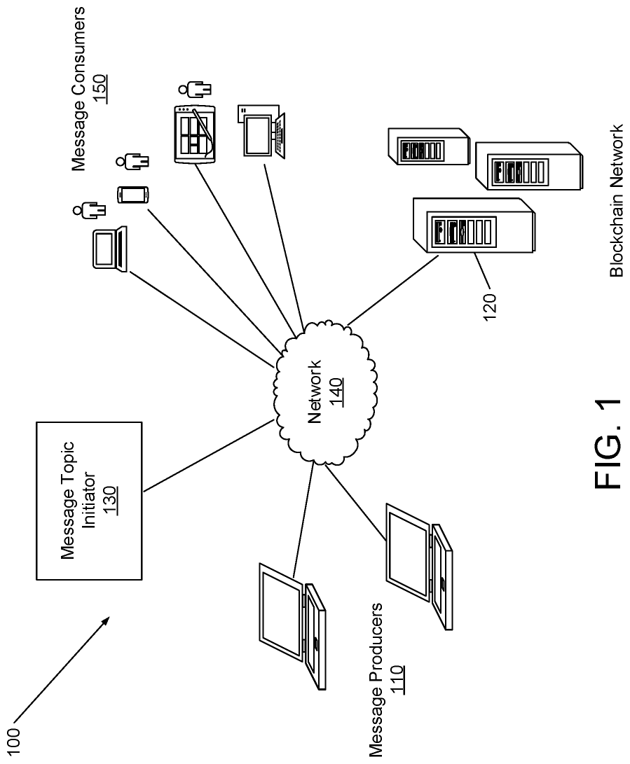

FIG. 1 shows an architectural level schematic of a distributed messaging system 100 in which one or more aspects described herein may be implemented. The distributed messaging system 100 includes a network 140, a blockchain network 120, a message topic initiator 130, a plurality of message producers 110, and a plurality of message consumers 150. The plurality of message producers 110 and the plurality of message consumers 150 are connected to the blockchain network 120 through the network 140. In some embodiments, the plurality of message producers 110 and the plurality of message consumers 150 may be nodes of the blockchain network 120. The blockchain network may include one or more nodes that store one or more smart contracts acting as message brokers between the plurality of message producers 110 and the plurality of message consumers 150. The message producers 110 may interact with the smart contracts in the blockchain network 120 through the network 140. The message producers 110 may be computing devices sending messages to the message consumers 150. Similar to the message producers, the message consumers may be computing devices which receive messages from the smart contracts in the blockchain network 120 sent by the message producers 110. The message topic initiator 140 may also be connected to the blockchain network 120 through the network 140.

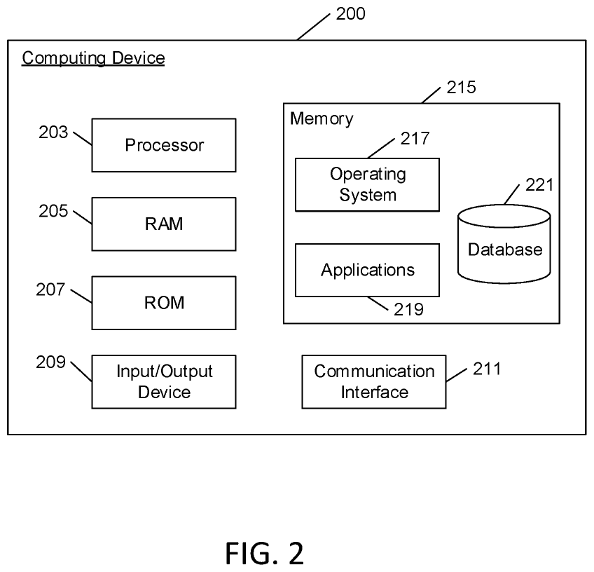

The communications between the message topic initiator 130, the message producers 110, the message consumers 150 and the nodes in the blockchain network 120 may occur over a variety of network 140, e.g., private networks, VPN, or Internet, and may use appropriate application programming interfaces (APIs) and data interchange formats, e.g., Representational State Transfer (REST), JavaScript™ Object Notation (JSON), Extensible Markup Language (XML), Simple Object Access Protocol (SOAP), Java™ Message Service (JMS), and/or Java Platform Module System. Some of the communications may be encrypted. The network 140 may be a LAN (local area network), a WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi, 5G and WiMAX. Additionally, a variety of authorization and authentication techniques, such as username/password, Open Authorization (OAuth), Kerberos, SecureID, digital certificates, and more, may be used to secure the communications. It will be appreciated that the network connections shown in the distributed messaging system 100 are illustrative, and any means of establishing a communications link between the computers may be used. Any of the nodes, devices, and systems described herein may be implemented, in whole or in part, using one or more computing systems described with respect to FIG. 2. The data transferred to and from various computing devices in the distributed messaging system 100 may include secure and sensitive data, such as confidential documents, customer personally identifiable information, and account data. Therefore, it may be desirable to protect the transmissions of such data using secure network protocols and encryption, and/or to protect the integrity of the data when stored on the various computing devices.

The blockchain network 120 may comprise a plurality of nodes that store, modify distributed ledgers and/or execute smart contracts as described herein. The distributed ledger in blockchain network 120 may store message sent by message producers to the message consumers. The distributed ledger may also store events indicating that a message consumer has viewed or received a message. A blockchain network may be publicly accessible and/or have restricted access. Access to a blockchain network may be limited to a particular distributed messaging system. The blockchain network 120 may comprise one or more distributed ledger data structures comprising a blockchain. This distributed ledger data structure may be replicated among some or all of the nodes in the blockchain network 120. Blockchain transactions or records may be time-stamped and bundled into blocks where each block is identified by its cryptographic hash called the consensus proof. The consensus proof may be determined by performing complex cryptographic computations with a consensus algorithm. One skilled in the art would appreciate that, in an implementation, the consensus proof may be determined by any consensus algorithm. The distributed ledger data structure may be a mutation-resistant and durable data structure which maintains records of the blockchain transactions that are tamper-resistant. Once a blockchain transaction is recorded in a block, it cannot be altered or deleted.

The message topic initiator 130 may generate smart contracts in the blockchain network 120 for distributing messages from the message producers to the message consumers. In some embodiments, the message topic initiator 130 may be a computing device or a node in the blockchain network 120.

In some embodiments, one or more web services may be implemented within the various computing devices. Web services may be accessed by the message producers 110 to send messages and execute blockchain transactions in the blockchain network 120 in the distributed messaging system 100. Web services may also be accessed by the message consumers 150 to receive and view messages, and execute blockchain transactions in the blockchain network 120. Web services built to support a personalized display system may be cross-domain and/or cross-platform and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, and/or firewalls. Such specialized hardware may be installed and configured in front of one or more computing devices such that any external devices may communicate directly with the specialized hardware.

Some or all of the data related to the distributed messaging system in the distributed messaging system 100 in FIG. 1 may be stored using one or more databases in the blockchain network 120. Databases may include but are not limited to relational databases, hierarchical databases, distributed databases, in-memory databases, flat file databases, XML databases, NoSQL databases, graph databases, and/or a combination thereof.

Turning now to FIG. 2, a computing device 200 that may be used with one or more of the computational systems is described. The computing device 200 may include a processor 203 for controlling the overall operation of the computing device 200 and its associated components, including RAM 205, ROM 207, input/output device 209, communication interface 211, and/or memory 215. A data bus may interconnect processor(s) 203, RAM 205, ROM 207, memory 215, I/O device 209, and/or communication interface 211. In some embodiments, computing device 200 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 209 may include a microphone, keypad, touch screen, and/or stylus through which a user of the computing device 200 may provide input, and may also include one or more of a speaker for providing audio output and a video display device for providing textual, audiovisual, and/or graphical output. Software may be stored within memory 215 to provide instructions to processor 203, allowing computing device 200 to perform various actions. Memory 215 may store software used by the computing device 200, such as an operating system 217, application programs 219, and/or an associated internal database 221. The various hardware memory units in memory 215 may include volatile and nonvolatile, removable and non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read-only memory (ROM) 207, electronically erasable programmable read-only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Communication interface 211 may include one or more transceivers, digital signal processors, and/or additional circuitry and software for communicating via any network, wired or wireless, using any protocol as described herein.

Processor 203 may include a single central processing unit (CPU), which may be a single core or multi-core processor, or may include multiple CPUs. Processor(s) 203 and associated components may allow the computing device 200 to execute a series of computer-readable instructions to perform some or all of the processes described herein. Although not shown in FIG. 2, various elements within memory 215 or other components in computing device 200, may include one or more caches including, but not limited to, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 200 are described separately, the functionality of the various components may be combined and/or performed by a single component and/or multiple computing devices in communication without departing from the invention.

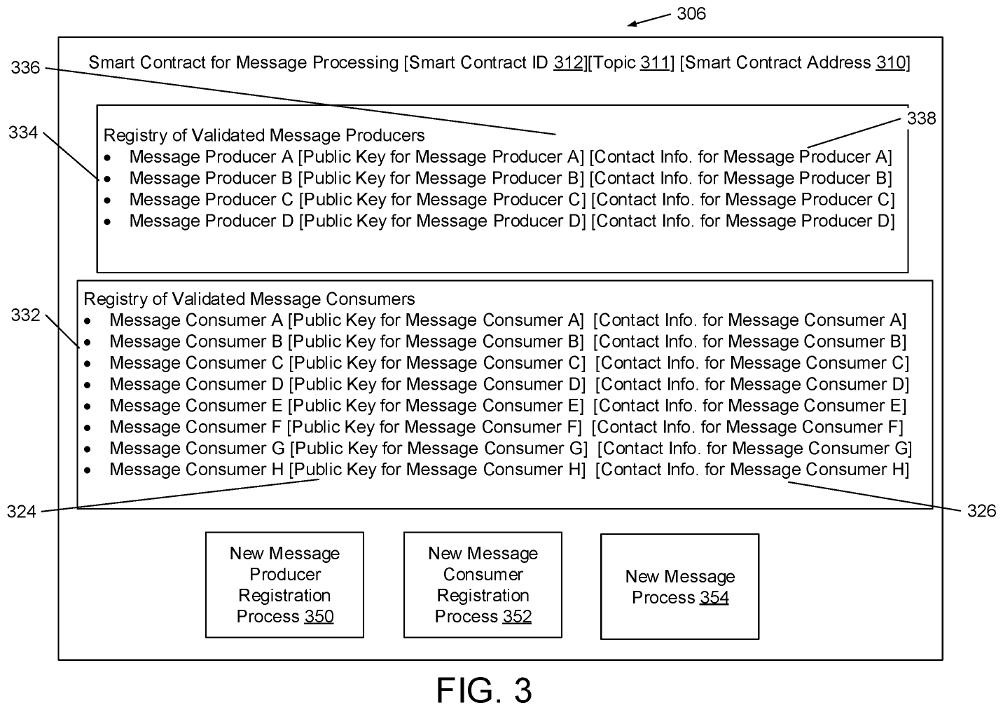

FIG. 3 shows an example of a smart contract 306 that may be executed in the blockchain network 120 in accordance with one or more aspects described herein. The smart contract 130 may be associated with a smart contract ID 312, a smart contract address 310 and a message topic 311. The smart contract address may be a unique identifier for the smart contract in the blockchain network. In many embodiments, the smart contract address may include an alphanumeric string beginning with the characters “0x”.

The smart contract 306 may include software components (e.g., code, instructions, rule sets) referred to herein as new message producer registration process 350, new message consumer registration process 352 and new message process 354. The smart contract 306 may also include a registry of validated message producers 334, and a registry of validated message consumers 332.

The registry of validated message producers 334 may contain information regarding the message producers eligible to send messages regarding the message topic 311 to one or more members of the registry of message consumers 332. The registry of validated message producers 334 may also include encryption keys associated with the validated message producers, such as the public keys 336 of the validated message producers. In some embodiments, the registry of validated message producers 334 may include other optional information that might be helpful for the functionality of the distributed messaging system, e.g., contact information 338 of the validated message producers (e.g., address, phone number, email addresses, MAC addresses, IP addresses, etc.). The distributed messaging system may use the contact information to send a message to the message producers.

The registry of validated message consumers 332 may contain information regarding the message consumers eligible to receive messages regarding the message topic 311 from one or more members of the registry of message producers 334. The registry of validated message consumers 332 may also include encryption keys associated with the validated message consumers, such as the public keys 324 of the validated message consumers. In some embodiments, the registry of validated message consumers 332 may include other optional information that might be helpful for the functionality of the distributed messaging system, e.g., contact information 326 of the validated message consumers (e.g., address, phone number, email addresses, MAC addresses, IP addresses, etc.). The distributed messaging system may use the contact information to forward messages to the message consumers.

The new message producer registration process 350 may process requests from message producers to be members of the registry of validated message producers 334. The new message consumer registration process 352 may process requests from message consumers to be members of the registry of validated message consumers 332. The new message process 354 may process messages from message producers to forward them to one or more members of the registry of validated message consumers 332.

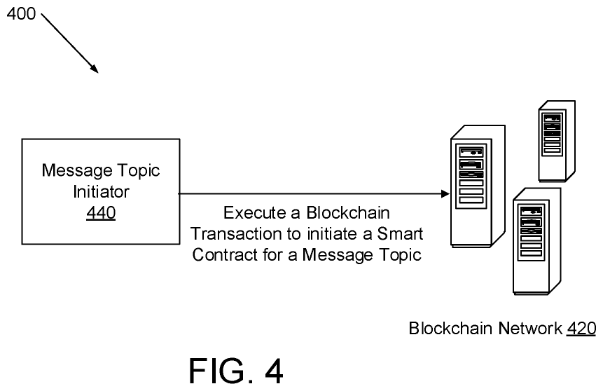

FIG. 4 shows an example process 400 for creating a smart contract in the blockchain network 420 in accordance with one or more aspects described herein. The process 400 may be performed using one or more computing devices as described herein. The message topic initiator 440 may receive a request to broker message of a certain topic and deploy a smart contract in the blockchain network 420 for distributing messages from the message producers to the message consumers.

In order to deploy the smart contract in the blockchain network 420, the message topic initiator 440 may provide the code for the software components in the smart contract (e.g., the new message producer registration process, the new message consumer registration process, and the new message process). The message topic initiator 440 may compile the code for the smart contract into bytecode and application interfaces. Bytecode may be a form of instruction set designed for efficient execution by a software interpreter in the blockchain network 420. The application interfaces may comprise public functions declared in the smart contract. The message topic initiator 440 may create a new instance of the smart contract and executes a blockchain transaction comprising the new instance. The executed blockchain transaction may be broadcasted to nodes in the blockchain network 420 to be mined and included in the blockchain network 420. The smart contract may be available at a smart contract address determined by a node in the blockchain network mining the smart contract. A message producer or a message consumer may invoke software components of the smart contract through the application interface by executing blockchain transactions addressed to the smart contract address.

### Validating a Message Producer

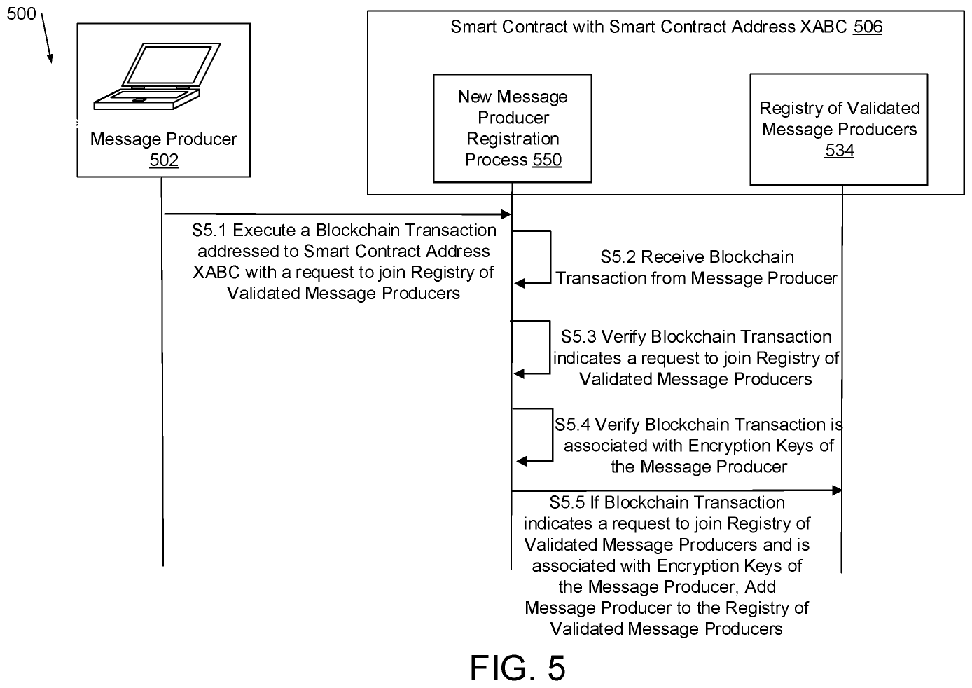

FIG. 5 shows a timing diagram 500 of a process for registering a new message producer 502 in accordance with one or more aspects described herein. Some or all of the steps of the timing diagram 500 may be performed using one or more computing devices as described herein. In some embodiments, the actions in the timing diagram may be performed in different orders and with different, fewer, or additional actions than those illustrated in FIG. 5. Multiple actions may be combined and/or divided into sub-actions in some implementations.

The timing diagram 500 begins at step S5.1, where a message producer 502 executes a blockchain transaction addressed to the smart contract address of the smart contract 506. The blockchain transaction may indicate a request to join the registry of validated message producer and comprise a cryptographic signature unique to the message producer. The cryptographic signature may be associated with the private key of the message producer 502.

At step S5.2, the new message producer registration process 550 in the smart contract 506 receives the blockchain transaction executed by the message producer 502.

The new message producer registration process 550 in the smart contract 506 may determine whether the message producer 502 is eligible to be a member of the registry of validated message producer based on a set of rules. The set of rules may include rules such as a rule specifying that the blockchain transaction executed by the message producer indicates a request to join the registry and/or a rule specifying that the blockchain transaction comprises a cryptographic signature associated with the encryption keys of the message producer. The set of rules may further include rules that the blockchain transaction indicates a topic category of the messages they message producer will send later on, and so on.

At step S5.3, the new message producer registration process 550 in the smart contract 506 may verify whether the blockchain transaction executed by the message producer 502 indicates a request to join the registry of validated message producers.

At step S5.4, the new message producer registration process 550 in the smart contract 306 may verify whether the blockchain transaction executed by the message producer 502 comprises a cryptographic signature associated with the encryption keys of the message producer. The new message producer registration process 550 may perform the verification by determining whether the cryptographic signature may be decrypted by public keys associated with the message producer 502.

At step S5.5 if the blockchain transaction executed by the message producer 502 indicates a request to join the registry of validated message producers and comprises a cryptographic signature associated with the encryption keys of the message producer, the new message producer registration process 550 may add the message producer 502 as a member of the registry of validated message producers 534 of the smart contract 506.

If the blockchain transaction executed by the message producer 502 does not indicate a request to join the registry of validated message producers and/or comprise a cryptographic signature associated with the encryption keys of the message producer, the new message producer registration process 550 may not add the message producer 502 as a member of the registry of validated message producers 534 of the smart contract 506.

### Validating a Message Consumer

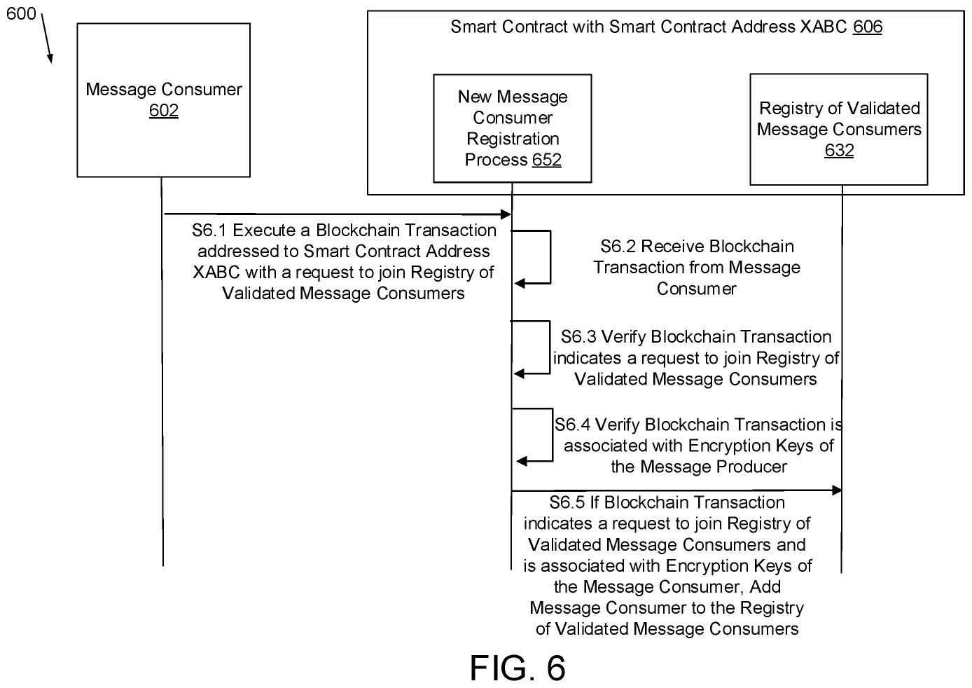

FIG. 6 shows a timing diagram 600 of a process for registering a new message consumer 602 in accordance with one or more aspects described herein. Some or all of the steps of the timing diagram 600 may be performed using one or more computing devices as described herein. In some embodiments, the actions in the timing diagram may be performed in different orders and with different, fewer, or additional actions than those illustrated in FIG. 6. Multiple actions may be combined and/or divided into sub-actions in some implementations.

The timing diagram 600 begins at step S6.1, where a message consumer 602 executes a blockchain transaction addressed to the smart contract address of the smart contract 606. The blockchain transaction may indicate a request to join the registry of validated message consumer and comprise a cryptographic signature unique to the message consumer. The cryptographic signature may be associated with the private key of the message consumer 602.

At step S6.2, the new message consumer registration process 652 in the smart contract 606 receives the blockchain transaction executed by the message consumer 602.

The new message consumer registration process 652 in the smart contract 606 may determine whether the message consumer 602 is eligible to be a member of the registry of validated message consumer based on a set of rules, such as a rule specifying whether the blockchain transaction executed by the message consumer indicates a request to join the registry and a rule specifying whether the blockchain transaction comprises a cryptographic signature associated with the encryption keys of the message consumer. The set of rules may further include rules that the blockchain transaction indicates a topic category of the messages they message consumer will send later on, and so on.

At step S6.3, the new message consumer registration process 652 in the smart contract 606 may verify whether the blockchain transaction executed by the message consumer 602 indicates a request to join the registry of validated message consumers.

At step S6.4, the new message consumer registration process 652 in the smart contract 606 may verify whether the blockchain transaction executed by the message consumer 602 comprises a cryptographic signature associated with the encryption keys of the message consumer. The new message consumer registration process 652 may perform the verification by determining whether the cryptographic signature may be decrypted by public keys associated with the message consumer 602.

At step S6.5 if the blockchain transaction executed by the message consumer 602 indicates a request to join the registry of validated message consumers and comprises a cryptographic signature associated with the encryption keys of the message consumer, the new message consumer registration process 652 adds the message consumer 602 as a member of the registry of validated message consumers 632 of the smart contract 606.

If the blockchain transaction executed by the message consumer 602 does not indicate a request to join the registry of validated message consumers and/or comprise a cryptographic signature associated with the encryption keys of the message consumer, the new message consumer registration process 652 may not add the message consumer 602 as a member of the registry of validated message consumers 632 of the smart contract 606.

### Processing Messages

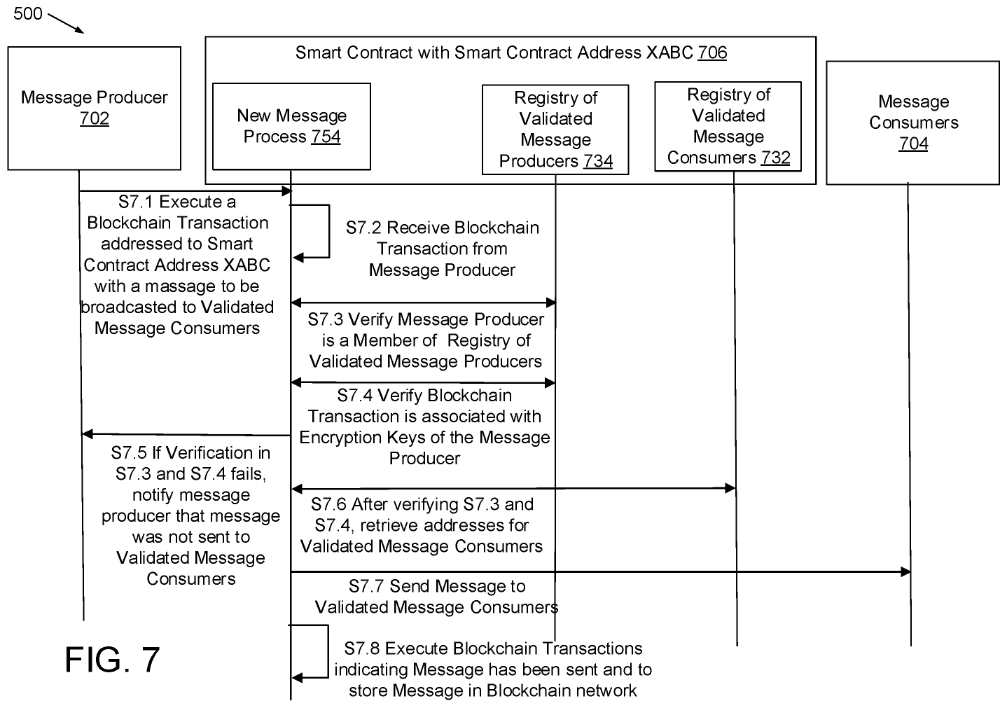

FIG. 7 shows a timing diagram 700 of a process for sending a message by a message producer 702 in accordance with one or more aspects described herein. Some or all of the steps of the timing diagram 700 may be performed using one or more computing devices as described herein. In some embodiments, the actions in the timing diagram may be performed in different orders and with different, fewer, or additional actions than those illustrated in FIG. 7. Multiple actions may be combined and/or divided into sub-actions in some implementations.

The timing diagram 700 begins at step S7.1, where a message producer 702 executes a blockchain transaction addressed to the smart contract address of the smart contract 706. The blockchain transaction may comprise a message to be sent out to one or more validated message consumers and a cryptographic signature unique to the message producer. The cryptographic signature may be associated with the private key of the message producer 702.

At step S7.2, the new message process 754 in the smart contract 706 receives the blockchain transaction executed by the message producer 702.

The new message process 754 in the smart contract 706 may determine whether the message is eligible to be forwarded to members of the registry of validated message consumers 732 based on a set of rules, such as a rule specifying whether the message producer 702 is a member of the registry of validated message producers and a rule specifying whether the blockchain transaction comprises a cryptographic signature associated with the encryption keys of the message producer 702. The set of rules may further include rules that the blockchain transaction indicates a topic category, and that objects in the message meet one or more requirements. Requirements may include that the message is within a certain world limit, be formatted according to a certain template and so on.

At step S7.3, the new message process 754 in the smart contract 706 may verify whether the message producer 702 is a member of the registry of validated message producers 734.

At step S7.4, the new message process 754 in the smart contract 706 may verify whether the blockchain transaction executed by the message producer 702 comprises a cryptographic signature associated with the encryption keys of the message producer 702 stored in the registry of validated message producers 734. The new message process 754 may perform the verification by determining whether the cryptographic signature can be decrypted by public keys associated with the message producer 702.

At step S7.5, if the message producer 702 is not a member of the registry of validated message producers 734 and/or if the blockchain transaction executed by the message producer 702 does not comprise a cryptographic signature associated with the encryption keys of the message producer 702, the new message process 754 may send a notification or a message to the message producer 702 that the message has been rejected and not been sent to message consumers.

At step S7.6, if the message producer 702 is a member of the registry of validated message producers 734 and/or if the blockchain transaction executed by the message producer 702 comprises a cryptographic signature associated with the encryption keys of the message producer 702, the new message process 754 may retrieve contact information of one or more validated message consumers from the registry of validated message consumers 732 and send the message to the one or more validated message consumers 704 at step S7.7. In some embodiments, the new message process 754 may send a block number for the block storing the blockchain transaction executed by the message producer 702 and comprising the message to the one or more validated message consumers.

At step S7.8 the new message process 754 may execute a blockchain transaction in the blockchain network, indicating that the message has been sent to the one or more validated message consumers at step S7.7. The new message process 754 may also execute a blockchain transaction comprising the message in the blockchain network to store the message in the distributed ledger of the blockchain network.

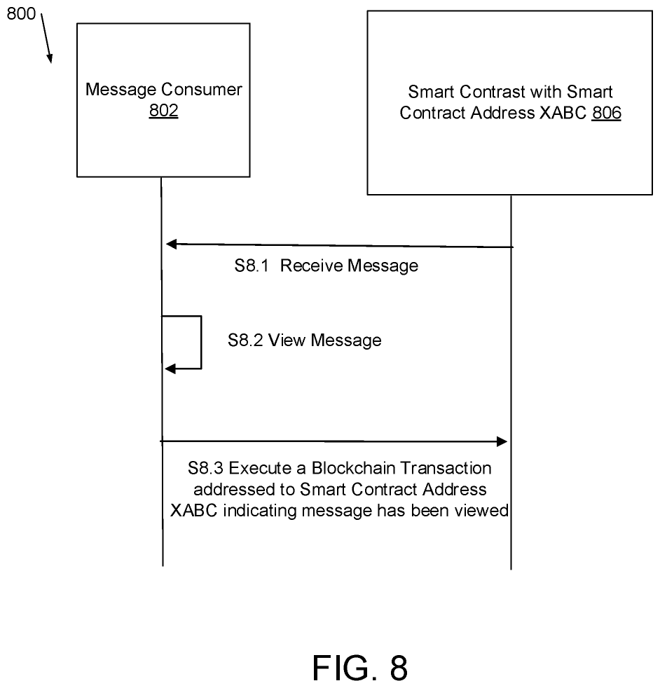

FIG. 8 shows a timing diagram 800 of a process of receiving a message by a message consumer 802 in accordance with one or more aspects described herein. Some or all of the steps of the timing diagram 800 may be performed using one or more computing devices as described herein. In some embodiments, the actions in the timing diagram may be performed in different orders and with different, fewer, or additional actions than those illustrated in FIG. 8. Multiple actions can be combined and/or divided into sub-actions in some implementations.

The timing diagram 800 begins at step S8.1, where a message consumer 802 receives a message sent by the message producer through the smart contract 806. In some embodiments, the message consumer 802 may receive a block number for the block storing the blockchain transaction executed by the message producer and comprising the message.

At step S8.2, the message consumer 802 may view or process the message. The message consumer 802 may process the message to identify one or more instructions to be performed by the message consumer or identify events that have happened.

At step S8.3, the message consumer 802 may execute a blockchain transaction in the blockchain network and addressed to the smart contract 806, indicating that the message has been viewed by the message consumer 802. In some embodiments, the blockchain transaction may comprise a message ID of the message. In some embodiments where a block number for the block storing the blockchain transaction executed by the message producer and comprising the message is sent to the message consumer 802, the blockchain transaction executed by the message consumer 802 may comprise the block number. The smart contract 806 may receive the blockchain transaction executed by the message consumer 802.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is, therefore, to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. An apparatus comprising:
one or more processors; and
memory storing instructions, when executed by the one or more processors, cause the apparatus to:
cause execution of a plurality of smart contracts maintained by a blockchain network, wherein each of the plurality of smart contracts manages a message topic, comprises a registry of validated message producer devices and a registry of validated message consumer devices, and is configured to:
receive, from a message producer device, a first blockchain transaction executed by the message producer device;
verify the first blockchain transaction to add the message producer device to the registry of validated message producer devices, wherein the verification is based on:
a determination that the first blockchain transaction comprises a request from the message producer device to join the registry of validated message producer devices; and
a determination that the first blockchain transaction is associated with encryption keys of the message producer device;
add the message producer device, based on the verification of the first blockchain transaction, to the registry of validated message producer devices;
receive, from a message consumer device, a second blockchain transaction executed by the message consumer device;
verify the second blockchain transaction to add the message consumer device to the registry of validated message consumers, wherein the verification is based on:
a determination that the second blockchain transaction comprises a request from the message consumer device to join the registry of validated message consumer devices; and
a determination that the second blockchain transaction is associated with encryption keys of the message consumer device;
add the message consumer device, based on the verification of the second blockchain transaction, to the registry of validated message consumer devices;
receive, from a validated message producer device from the registry of validated message producer devices, a third blockchain transaction executed by the validated message producer device, wherein the third blockchain transaction comprises a message associated with the message topic;
verify the third blockchain transaction, wherein the verification is based on:
a determination that the validated message producer device is a member of the registry of validated message producer devices;
a determination that the third blockchain transaction is associated with encryption keys of the validated message producer device; and
send, based on the verification of the third blockchain transaction, the message to one or more members of the registry of validated message consumer devices.

2. The apparatus of claim 1, wherein the instructions, when executed by the one or more processors, further cause the apparatus to:
store the message in a distributed ledger stored using a set of nodes in the blockchain network.

3. The apparatus of claim 2, wherein each of the plurality of smart contracts is further configured to send the message to the one or more members of the registry of validated message consumers by sending, to the one or more members of the registry of validated message consumers, a block number for a block in the distributed ledger storing the message.

4. The apparatus of claim 1, wherein each of the plurality of smart contracts is further configured to:
receive a fourth blockchain transaction executed by one of the one or more members of the registry of validated message consumer devices, wherein the fourth blockchain transaction comprises an indication that said one of the one or more members of the registry of validated message consumer devices have viewed the message.

5. The apparatus of claim 1, wherein each of the plurality of smart contracts is further configured to:
execute a fifth blockchain transaction, wherein the fifth blockchain transaction comprises an indication that the message has been sent to the one or more members of the registry of validated message consumer devices.

6. (canceled)

7. A method comprising:
storing, by a smart contract maintained by a blockchain network comprising a set of nodes and managing a message topic, a registry of validated message producer devices and a registry of validated message consumer devices;
receiving, by the smart contract and from a validated message producer device from the registry of validated message producer devices, a first blockchain transaction executed by the validated message producer in the blockchain network, wherein the first blockchain transaction comprises a message associated with the message topic;
verifying, by the smart contract, the first blockchain transaction based on:
a determination that the validated message producer device is a member of the registry of validated message producer devices; and
a determination that the first blockchain transaction is associated with encryption keys of the validated message producer device;
sending, by the smart contract and based on the verification of the first blockchain transaction, the message to one or more validated message consumer devices in the registry of validated message consumer devices;
receiving, by the smart contract, a second blockchain transaction executed by a validated message consumer device from the registry of validated message consumer devices, wherein the second blockchain transaction comprises an indication that the validated message consumer device has viewed the message; and
broadcasting, by the smart contract, the second blockchain transaction to nodes in the set of nodes in the blockchain network.

8. The method of claim 7, wherein the validated message producer device and the one or more validated message consumer devices are nodes in the set of nodes in the blockchain network.

9. The method of claim 7, further comprising storing the message in a distributed ledger stored using the set of nodes in the blockchain network.

10. The method of claim 9, wherein sending the message to the one or more validated message consumer devices in the registry of validated message consumer devices comprises:
sending, to the one or more validated message consumer devices, a block number for a block in the distributed ledger storing the message.

11-12. (canceled)

13. The method of claim 7, further comprising:
receiving, by the smart contract and from a message producer device, a third blockchain transaction executed by the message producer device, wherein the third blockchain transaction comprises a request to join the registry of validated message producer devices;
verifying, by the smart contract, that the third blockchain transaction is associated with encryption keys of the message producer device; and
add the message producer device, by the smart contract, as a validated message producer device to the registry of validated message producer devices.

14. The method of claim 7, further comprising:
receiving, by the smart contract and from a message consumer, a third blockchain transaction executed by the message consumer device, wherein the third blockchain transaction comprises an indication to join the registry of validated message consumer devices;
verifying, by the smart contract, that the third blockchain transaction is associated with encryption keys of the message consumer; and
add the message consumer, by the smart contract, as a validated message consumer device to the registry of validated message consumer devices.

15. The method of claim 7, further comprising:
executing, by the smart contract, a third blockchain transaction, wherein the third blockchain transaction comprises an indication that the message has been sent to the one or more validated message consumer devices in the registry of validated message consumer devices; and
broadcast, by the smart contract, the third blockchain transaction to nodes in the set of nodes in the blockchain network.

16. A non-transitory machine-readable medium storing instructions that, when executed by one or more processors, cause the one or more processors to perform steps comprising:
causing execution of a plurality of smart contracts maintained in a blockchain network comprising a set of nodes, wherein each of the plurality of smart contracts manages a message topic, comprises a registry of validated message producer devices and a registry of validated message consumer devices, and is configured to:
receive, from a node from the set of nodes of the blockchain network, a first blockchain transaction executed by a message producer device;
verify the first blockchain transaction to add the message producer device to the registry of validated message producer devices, wherein the verification is based on:
a determination that the first blockchain transaction comprises an indication to join the registry of validated message producer devices; and
a determination that the first blockchain transaction is associated with encryption keys of the message producer device;
add the message producer device, based on the verification of the first blockchain transaction, to the registry of validated message producer devices;
receive, from the node, a second blockchain transaction executed by a message consumer;
verify the second blockchain transaction to add the message consumer device to the registry of validated message consumer devices, wherein the verification is based on:
a determination that the second blockchain transaction comprises an indication to join the registry of validated message consumer devices; and
a determination that the second blockchain transaction is associated with encryption keys of the message consumer;
add the message consumer, based on the verification of the second blockchain transaction, to the registry of validated message consumer devices;
receive, from the node, a third blockchain transaction executed by a validated message producer device from the registry of validated message producer devices, wherein the third blockchain transaction comprises a message;
verify the third blockchain transaction, wherein the verification is based on:
a determination that the validated message producer device is a member of the registry of validated message producer devices;
a determination that the third blockchain transaction is associated with encryption keys of the validated message producer device;
send, based on the verification of the third blockchain transaction, the message to one or more members of the registry of validated message consumer devices;
execute a fourth blockchain transaction, wherein the fourth blockchain transaction comprises an indication that the message has been sent to the one or more members of the registry of validated message consumer devices; and
receive a fifth blockchain transaction executed by one of the one or more members of the registry of validated message consumer devices, wherein the fifth blockchain transaction comprises an indication that said one of the one or more members of the registry of validated message consumer devices had viewed the message.

17. The non-transitory machine-readable medium of claim 16, wherein the instructions that, when executed by one or more processors, further cause the one or more processors to perform steps comprising:
storing the message in a distributed ledger stored using the set of nodes in the blockchain network.

18. The non-transitory machine-readable medium of claim 17, wherein the sending the message to the one or more members of the registry of validated message consumer devices comprises sending, to the one or more members of the registry of validated message consumer devices, a block number for a block in the distributed ledger storing the message.

19. (canceled)

20. The non-transitory machine-readable medium of claim 16, wherein validated message producer devices in the registry of validated message producer devices and validated message consumer devices from the registry of validated message consumer devices are nodes in the set of nodes in the blockchain network.
